(19) United States
(12) Patent Application Publication
(10) Pub. No.: US 2013/0332186 A1
(43) Pub. Date: Dec. 12, 2013

(54) METHODS AND APPARATUS FOR HEALTHCARE PAYMENT PROCESSING

(71) Applicant: athenahealth, Inc., Watertown, MA (US)

(72) Inventors: Daniel Epstein, Somerville, MA (US); Aaron Homer, Belmont, MA (US); Jason Chang, Melrose, MA (US); Jeff Kibler, South Boston, MA (US); Cezary Wislocki-Wasecki, Natick, MA (US); Geoffry Maletta, Northborough, MA (US); Robert Nix, Concord, MA (US)

(73) Assignee: athenahealth, Inc., Watertown, MA (US)

(21) Appl. No.: 13/965,032

(22) Filed: Aug. 12, 2013

Related U.S. Application Data
(62) Division of application No. 13/416,292, filed on Mar. 9, 2012, now abandoned.
(60) Provisional application No. 61/451,999, filed on Mar. 11, 2011.

(51) Int. Cl. G06F 19/00

(52) U.S. Cl. CPC G06F 19/328
USPC 705/2

(57) ABSTRACT

Methods and apparatus for facilitating a payment collection process by enabling a patient to pre-authorize payment for future medical services not covered by the patient's healthcare payer. Rather than sending a statement to a patient instructing the payment to remit an outstanding balance, a practice management system automatically applies electronic funds for the patient's outstanding balance in accordance with terms of a contract executed between the patient and the medical practice at the time of service. By including contract terms such as a predefined maximum charge amount and limited contract duration, patients may feel that their electronic account information is safe and that they will be billed only for what they owe. Additionally, medical practices may have better assurance that remittance for medical services will be paid promptly by patients under the terms of the contract.

### RELATED APPLICATIONS

This application claims the benefit under 35 U.S.C. §120 of U.S. application Ser. No. 13/416,292, entitled “METHODS AND APPARATUS FOR HEALTHCARE PAYMENT PROCESSING” filed on Mar. 9, 2012, which claims priority under 35 U.S.C. §119(e) to U.S. Provisional Application Ser. No. 61/451,999, entitled “METHODS AND APPARATUS FOR HEALTHCARE PAYMENT PROCESSING” filed on Mar. 11, 2011, both applications of which are herein incorporated by reference in their entireties.

### BACKGROUND

In modern healthcare systems, individuals typically have access to a large number of healthcare payers which vary in their payment coverage for services rendered by medical practices. The complexities introduced by the large number of healthcare payer options available to patients of a medical practice may result in underpayment for services provided by the medical practice in the absence of an administrative system that can effectively resolve these complexities.

Ensuring that medical practices are properly reimbursed for the services that they provide to patients is an important consideration for the medical practices. A medical practice typically initiates a reimbursement process by sending one or more claims describing a patient's medical services to a patient's healthcare payer. Based on the scope of coverage of the patient's health insurance plan, the payer remits payment to the medical practice or denies the claim. In some instances, the payer may remit only a portion of the total balance and the patient is responsible for remitting payment to the medical practice for the outstanding balance not covered by the patient's healthcare insurance plan. The medical practice may issue a statement to the patient detailing the unpaid charges with instructions for remitting payment to the medical practice to pay the outstanding balance.

To assist in the processing of claims, some medical practices may contract with a third party which provides a practice management system for facilitating and tracking the status of claims submitted to the multitude of healthcare payers chosen by patients of the medical practice. For example, the practice management system may be a network-based system that enables billing personnel at a medical practice to view the status of claims submitted to a patient's healthcare payer to determine if and when remittance for the claims is received. If remittance is not received, the billing personnel may investigate the situation further to determine a reason for the denial of the claims so that additional steps may be taken to ensure that the claims are paid. This may include, among other things, sending a statement to the patient requesting that the patient remit the outstanding balance to the medical practice.

### SUMMARY

Some embodiments of the invention are directed to a method of facilitating a patient payment process. The method comprises forming a contract between the patient and a medical practice at the time of service, wherein the contract specifies one or more payment terms associated with future payments for medical services including electronic account information, determining a patient's outstanding balance based, at least in part, on information received from a healthcare payer, and automatically debiting at least a portion of the outstanding balance from the electronic account based, at least in part, on the one or more payment terms in the contract.

Some embodiments of the invention are directed to a method of creating a payment contract between a patient and medical service prior to knowing a patient liability, wherein the payment contract specifies a maximum amount that will be debited from the patient's account without further authorization.

Some embodiments of the invention are directed to a method of isolating and securely storing card information provided by a patient for remittance of future payments for medical services. The method comprises storing patient information associated with the card information on a practice management system, sending the card information to a secure server having at least one payment processing program executing thereon, receiving a token from the secure server, wherein the token links the patient information to the card information stored on the secure server, and storing the token on the practice management system by associating the token with the stored patient information.

Some embodiments of the invention are directed to an integrated practice management system configured to facilitate operations within a medical practice. The practice management system may provide a plurality of services to which medical practices may subscribe. The plurality of services include, but are not limited to, a patient payment processing service, a revenue cycle service, a practice management service, a patient communication service, and a healthcare information management service. The practice management system may implement a plurality of rules to enable information stored by the practice management system to be shared by one or more of the services hosted by the practice management system resulting in an integrated service offering for medical practice management.

Some embodiments of the invention are directed to a computer-readable medium encoded with a series of instructions, that when executed on a computer perform a method of applying electronic funds for medical payments based, at least in part, on a pre-authorization patient payment arrangement between a patient and a medical practice.

Some embodiments of the invention are directed to a medical billing claim processing system comprising at least one processor. The at least one processor is configured to present a web-based user interface to enable one or more users at a medical practice to manage one or more pre-authorization contracts created between a patient and the medical practice. The web-based user interface includes a plurality of pages with which the one or more users may interact to perform one or more actions related to the pre-authorization contracts. For example, the user interface may enable a user to create a new contract, view the terms of a contract, and/or cancel a contract.

Some embodiments of the invention have applications related to processing patient payments in accordance with one or more pre-authorization agreements between a patient and a medical practice executed at the time of service.

For example, some embodiments may be directed to:
A practice management system that implements a plurality of rules for creating and managing pre-authorization contracts between a patient and a medical practice.
Determining the validity of a pre-authorization contract prior to applying electronic funds for an outstanding balance according to the terms of the contract.
Receiving information related to at least one readjudicated claim from a healthcare payer and crediting or debiting an electronic account on file without user intervention.
Sending at least one notification to a patient prior to a scheduled payment transaction date.
Identifying one or more contract difficulties for pre-authorization contracts between a medical practice and patients of the medical practice.
Creating an automatic payment plan to facilitate a collection of an outstanding patient balance.
Generating one or more reports related to electronic payment activity for a medical practice.
Receiving payment card information and associating the card information with a pre-authorization contract for payment of future medical services, wherein the payment card information may relate to a credit card, a debit card, or a personal health account card such as a health savings account card or a flexible spending account card.

Some embodiments are directed to a method of generating a pre-authorization payment contract between a patient and a medical practice. The method comprises receiving from a patient, authorization to remit electronic funds for one or more future payments related to medical services provided by the medical practice; receiving electronic account information associated with the electronic funds; generating a pre-authorization payment contract based on the authorization received from the patient and the electronic account information, wherein the pre-authorization payment contract includes one or more payment terms governing the remittance of electronic funds for the one or more future payments; and storing the electronic account information and patient information associated with the pre-authorization payment contract on at least one datastore.

Some embodiments are directed to a method of processing healthcare payments. The method comprises receiving from a healthcare payer, an indication of an outstanding balance for a medical claim submitted to the healthcare payer on behalf of a medical practice; identifying a patient associated with the medical claim; determining whether the identified patient is associated with a pre-authorized payment contract; and applying based, at least in part, on one or more payment terms in the pre-authorized payment contract, electronic funds to at least a portion of the outstanding balance for the medical claim in response to determining that the identified patient is associated with a pre-authorized payment contract.

Some embodiments are directed to a computer system comprising at least one storage medium configured to store patient information related to a plurality of pre-authorization payment contracts between patients and medical practices; and a medical practice management server including at least one processor. The at least one processor is programmed to generate a pre-authorization payment contract based on authorization received from the patient and electronic account information associated with the patient, wherein the pre-authorization payment contract includes one or more payment terms governing the remittance of electronic funds for one or more future payments to a medical practice; and store the electronic account information and patient information associated with the pre-authorization payment contract on the at least one storage medium.

Some embodiments are directed to a medical practice management server configured to process healthcare payments in accordance with at least one pre-authorization payment contract, the medical practice management server comprising at least one processor. The at least one processor is programmed to receive from a healthcare payer, an indication of an outstanding balance for a medical claim submitted to the healthcare payer on behalf of a medical practice; identify a patient associated with the medical claim; determine whether the identified patient is associated with a pre-authorized payment contract; and apply based, at least in part, on one or more payment terms in the pre-authorized payment contract, electronic funds to at least a portion of the outstanding balance for the medical claim in response to determining that the identified patient is associated with a pre-authorized payment contract.

Some embodiments are directed to at least one computer-readable medium encoded with a plurality of instructions that, when executed by a computer, perform a method. The method comprises generating a pre-authorization payment contract based on authorization received from a patient of a medical practice and electronic account information associated with the patient, wherein the pre-authorization payment contract includes one or more payment terms governing the remittance of electronic funds for one or more future payments to a medical practice; and storing the electronic account information and patient information associated with the pre-authorization payment contract on at least one storage medium.

Some embodiments are directed to at least one computer-readable medium encoded with a plurality of instructions that, when executed by a computer, perform a method. The method comprises receiving from a healthcare payer, an indication of an outstanding balance for a medical claim submitted to the healthcare payer on behalf of a medical practice; identifying a patient associated with the medical claim; determining whether the identified patient is associated with a pre-authorized payment contract; and applying based, at least in part, on one or more payment terms in the pre-authorized payment contract, electronic funds to at least a portion of the outstanding balance for the medical claim in response to determining that the identified patient is associated with a pre-authorized payment contract.

It should be appreciated that some of the aforementioned concepts may be combined, whereas other concepts may provide the basis for patentably distinct inventions. To this end, the foregoing is provided as a non-limiting list of potentially patentable concepts related to patient payment collection using pre-authorized agreements as described herein, and other related concepts, despite not being included in the aforementioned list, are also contemplated as being part of the inventive subject matter embodied herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a practice management system in accordance with some embodiments of the invention;

FIG. 2 is a flow chart of a pre-authorization payment process in accordance with some embodiments of the invention;

FIG. 3 is a schematic of a portion of a user interface for generating a pre-authorized contract, in accordance with some embodiments of the invention;

FIG. 4 is a schematic of a portion of a user interface for specifying contract terms, in accordance with some embodiments of the invention;

FIG. 5 is a schematic of a portion of a user interface for specifying payment information, in accordance with some embodiments of the invention;

FIG. 6 is a schematic of a portion of a user interface for specifying security code information, in accordance with some embodiments of the invention;

FIG. 7 is a schematic of a portion of a user interface for specifying billing address information, in accordance with some embodiments of the invention;

FIG. 8 is an exemplary pre-authorized contract generated in accordance with some embodiments of the invention;

FIG. 9 is a schematic of a portion of a user interface for selecting a card-on-file contract, in accordance with some embodiments of the invention;

FIG. 10 is a block diagram of an exemplary payment processing system for use with some embodiments of the invention;

FIG. 11 is a flow chart of a card information processing process in accordance with some embodiments of the invention;

FIG. 12 is a flow chart of a payment transaction process in accordance with some embodiments of the invention;

FIG. 13 is a flow chart of a bill on EOB process in accordance with some embodiments of the invention;

FIG. 14 is a flow chart of a bill on readjudicated EOB in accordance with some embodiments of the invention;

FIG. 15 is a schematic of a portion of a user interface for managing contracts, in accordance with some embodiments of the invention;

FIG. 16 is a schematic of a portion of a user interface for managing failed payments, in accordance with some embodiments of the invention;

FIG. 17 is a schematic of a portion of a user interface for managing invalid notifications, in accordance with some embodiments of the invention;

FIG. 18 is a schematic of a portion of a user interface for managing contract details, in accordance with some embodiments of the invention;

FIG. 19 is a schematic of a portion of a user interface for filtering stored contract information, in accordance with some embodiments of the invention;

FIG. 20 is a schematic of a portion of a user interface for creating an electronic payment plan, in accordance with some embodiments of the invention;

FIG. 21 is a schematic of a portion of a user interface for generating a report, in accordance with some embodiments of the invention; and

FIG. 22 is a schematic of a network environment in which some embodiments of the invention may be employed.

### DETAILED DESCRIPTION

The present disclosure generally relates to inventive methods and apparatus for processing payments for medical services rendered by a medical practice, and more specifically relates to processing of patient payments for an outstanding balance using one or more pre-authorized contracts between a patient and a medical practice. To this end, some embodiments of the invention are directed to methods and apparatus for facilitating a payment collection process for a medical practice by enabling a patient during a patient visit to the medical practice to pre-authorize payment for medical services not covered by the patient's healthcare payer.

As healthcare costs continue to rise, patients are often required by their healthcare payers (e.g., healthcare insurance providers) to pay more of the healthcare costs out-of-pocket in the form of premiums, deductibles, coinsurance, copayments, and/or other forms of payment. However, collecting payments from patients for medical services is often a challenging process for medical practices for several reasons and can involve significant work, hassle, and cost. For example, some patients may refuse to pay and medical practices may need to send the patients multiple statements and in some instances resort to collection agencies to receive reimbursement for medical services provided to the patient. On average, medical practices may take more than 100 days to collect from patients and in some instances, practices may be unable to collect on a significant portion of the balances due to patients.

In some conventional healthcare revenue systems, the patient's healthcare payer may receive a claim from the medical practice explaining the medical services provided and the costs associated with the provided services. Based on the information in the claim and the patient's healthcare plan, the payer determines a payment amount to remit to the medical practice. In some instances, the payer may remit the entire balance for the medical services provided. However, in other instances, the payer may remit only a portion of the balance or the claim may be denied and the payer may not remit any payment to the medical practice. After a payer has determined which costs for medical services are covered by a patient's healthcare plan, the payer often sends the patient a form called an Explanation of Benefits (EOB) that includes information such as a payment amount that the payer will remit to the medical practice and an outstanding balance that the patient is responsible for paying to the medical practice. A copy of the EOB is sent to the medical practice, which sends a statement to the patient indicating that the patient is responsible for the outstanding balance not covered by the patient's healthcare payer and the statement may include instructions for remitting the outstanding balance to the medical practice.

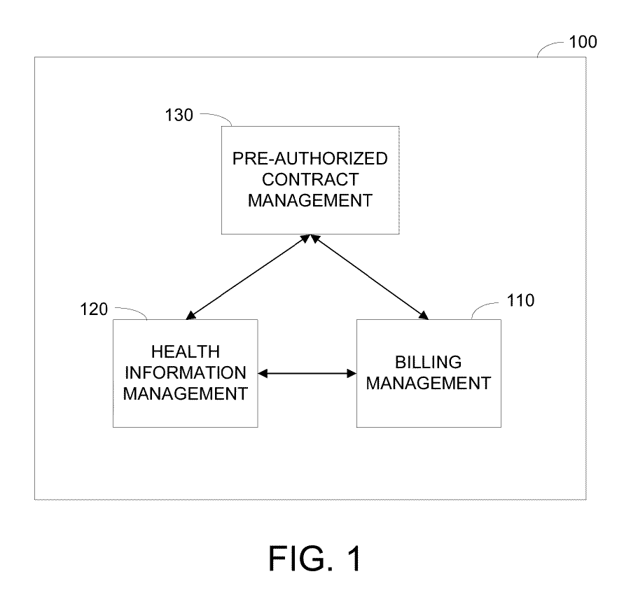

In accordance with some embodiments, a practice management system, which hosts a healthcare revenue cycle management program may be integrated with a pre-authorized patient payment agreement process to facilitate collection of outstanding balances from patients. A block diagram of an exemplary practice management system that may be used to implement some embodiments of the invention is shown in FIG. 1. Practice management system 100 may be a networked system that includes a plurality of components configured to perform tasks related to specific functions within the practice management system to facilitate management of information for healthcare providers.

Exemplary practice management system 100 includes billing management component 110, which is configured to facilitate the collection and tracking of claims filed by the healthcare provider to a plurality of payers (including patients) to ensure that the healthcare provider is properly compensated for medical services rendered to patients treated by the healthcare provider. Practice management system 100 also includes health information management component 120, which is configured to store electronic health information such as EHR data for patients of the healthcare provider. Practice management system 100 also includes pre-authorized contract management component 130, which interacts with health information management component 120 and billing management component 110 to facilitate a healthcare provider's ability to collect outstanding balances for medical services from patients. In some embodiments, components of practice management system may interact in accordance with a plurality of rules that facilitate the sharing of information between different components. The plurality of rules may be executed by one or more processors associated with the practice management system.

Although practice management system 100 is only shown as having three components, it should be appreciated that practice management system 100 may include any number of components that interact in any suitable way and embodiments of the invention are not limited in this respect. For example, in some embodiments, practice management system 100 may include a communications component configured to send and/or receive one or more communications with a plurality of patients having medical information stored by health information management component 120.

Furthermore, some or all of the components in practice management system 100 may interact by sharing data, triggering actions to be performed by other components, prevent actions from being performed by other components, storing data on behalf of other components, and/or interacting in any other suitable way. For example, as described in more detail below, a communications component of the practice management system may interact with pre-authorized contract management component 130 and/or billing management component 110 to facilitate sending notifications and receipts to patients in response to scheduling or processing a payment transaction in accordance with some embodiments of the invention. In some embodiments, practice management system 100 includes one or more storage devices configured to store data related to billing information, pre-authorized contracts, patient information, healthcare information, and any other suitable information.

Medical practices often find that collection directly from patients is challenging after the patient has left the medical practice. However, the inventors have recognized that when patients are asked to remit payment at the time of service (e.g., for a co-payment during a patient visit), most patients pay in full. Accordingly, it may be advantageous to bill patients for medical services at the time of service. However, accurately estimating the amount of payment that the patient will ultimately be responsible for is often difficult at the time of service because this amount may vary depending on remittance received from the patient's healthcare payer, as discussed above. Some embodiments of the invention are directed to a healthcare revenue system in which patients pre-authorize one or more future electronic payments at the time of service.

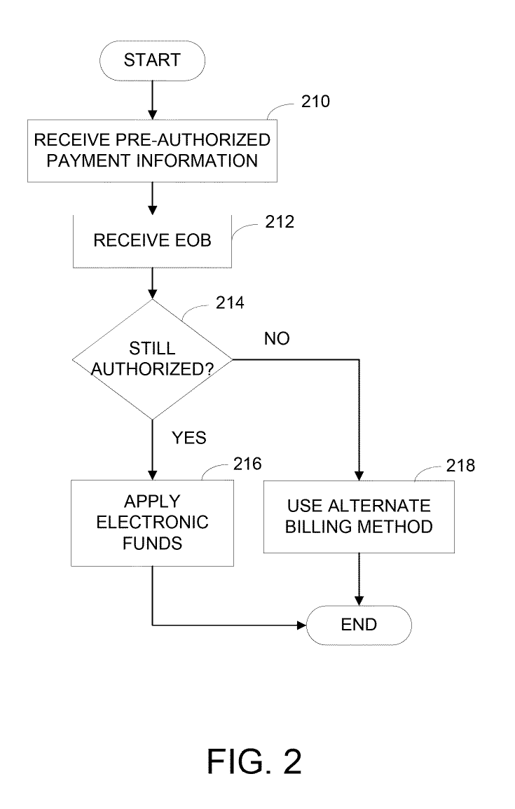

FIG. 2 illustrates a flow chart of a process for processing pre-authorized payments for medical services in accordance with some embodiments of the invention. In act 210, pre-authorized payment information is received. During check-in or check-out at a medical practice patients often interact with administrative personnel such as a front-desk receptionist. During these interactions, the administrative personnel may ask the patient for healthcare payer information such as an insurance card, which may identify a co-payment amount the patient is required to pay based on the patient's healthcare plan. Prior to leaving the medical practice, the patient may be asked to remit the co-payment amount to the medical practice as a condition for receiving medical services.

As discussed above, the inventors have recognized that it may be advantageous to ask patients to authorize future payments for medical services at the time the services are provided. Accordingly, in some embodiments, patients may be asked to provide authorization for future payments related to the provided medical services prior to leaving the medical practice. A patient may provide authorization in any suitable way and embodiments of the invention are not limited in this respect. For example, a patient may provide authorization for future payments by signing a contract with the medical practice at the time of service. Terms and conditions in exemplary contracts in accordance with some embodiments of the invention are described in more detail below. In some embodiments, the patient may have previously signed a contract with the medical practice providing authorization for future payments and authorization may be assumed if the contract has not been terminated or authorization may be provided by asking the patient to reauthorize the contract by, for example, swiping a particular card through a card reader. Although the patient may provide authorization by signing a contract, authorization may also be received in other ways and embodiments of the invention are not limited in this respect. For example, the patient may provide electronic account information to the medical practice for payment of future payments and the act of providing such information may be sufficient authorization for future payments.

In addition to providing authorization, the patient may also provide electronic account information to enable the medical practice to apply funds from the electronic account to future payments for the medical services. The electronic account may be associated with a card including, but not limited to, a credit card or a debit card. In some embodiments, the card may be associated with a personal health account such as a health savings account or a flexible spending account. In one embodiment described in more detail below, the electronic account information may be collected in response to a patient swiping a card through a card reader. The card reader may read the information on the card and transfer at least some of the electronic account information to a user interface provided by a practice management system.

Administrative personnel at the medical practice may interact with the user interface to verify the electronic account information and/or add any additional information, such as a security code printed on the card, into the user interface. In some embodiments, a patient may have previously used the electronic account information and the patient may have consented to the medical practice securely storing this information for future use and the stored electronic account information may be retrieved at the time of service. Even though the stored electronic account information may be automatically retrieved, in some embodiments the patient may be asked to provide confirmation of the retrieved account information to verify that the stored information is still correct.

In the above-described embodiments, the electronic account information is automatically collected. However, it should be appreciated that the electronic account information may also be manually collected. For example, some medical practices may not have the proper equipment for reading information from an electronic card and transferring the information to a user interface provided by a practice management system. Accordingly, the electronic account information may be collected by administrative personnel at the medical practice manually entering the electronic account information into a user interface provided by a practice management system. An exemplary method for processing electronic account information received from a patient during the time of service is discussed in further detail below.

After a patient has provided electronic account information with authorization to use of the electronic information to remit further payments for medical services, the patient may leave the medical practice and may not need to take any further action to ensure that the medical practice is paid for the provided medical services. Accordingly, after the electronic account information is received, the process proceeds to act 212, where information, such as an EOB, is received from a payer.

As discussed above, after providing medical services to a patient, a medical practice typically sends a claim to the patient's healthcare payer instructing the payer to remit payment to the medical practice for the provided medical services. In some embodiments, claims may be submitted to payers via a practice management system that facilitates the healthcare revenue operations of the medical practice. The payer reviews the information on the received claim and compares the provided medical services and costs with the patient's healthcare plan to determine how much of the costs the payer is obligated to pay. In some instances, the payer may determine that the payer is not obligated to remit payment for any of the costs on the claim, whereas in other instances the payer may remit some or all of the costs detailed in the claim to the medical practice. After determining which costs will be covered by the payer, the payer sends an EOB to the patient and the medical practice detailing which costs the payer will cover and which costs the patient is responsible for paying. The EOB also usually includes information regarding why the payer has refused to pay for certain medical services. When the medical practice has contracted with a third party hosting a practice management system, a copy of the EOB may also be sent to the third party for entry into the practice management system.

In response to receiving an EOB, the process proceeds to act 214 where it is determined whether the patient's authorization provided in act 210 is still valid. In some embodiments, contracts between patients and medical practices authorizing future payments may be cancelled prior to receiving an EOB. For example, after a patient has left a medical practice, the patient may decide that they would rather be sent a paper bill in the mail rather than using an automatic remittance process as described herein. The patient may contact the medical practice to cancel the contract and an authorized user at the medical practice may interact with a user interface provided by the practice management system to provide an indication that the contract is cancelled. An example of cancelling a contract in accordance with some embodiments of the invention is described in more detail below.

If it is determined in act 214 that the authorization for the patient associated with the EOB is no longer valid, the process proceeds to act 218 where an alternate billing method is used. For example, the alternate billing method may be sending the patient an electronic or paper statement detailing the charges not covered by the patient's healthcare payer and providing instructions for remitting payment for these outstanding charges to the medical practice. It should be appreciated however, that sending a statement to the patient is only one example of an alternate billing method and other alternate billing methods may also be used. For example, if it is determined in act 214 that the authorization is no longer valid, a component of the practice management system may generate one or more automated messages to the patient that provide the patient with information that would generally be provided on a statement.

If it is determined in act 214 that the authorization for the patient identified in the EOB is still valid, the process proceeds to act 216 where electronic funds identified in the authorization contract and/or the electronic account information are applied to the outstanding balance identified in the EOB. For example, if the patient has authorized the use of a credit card for future payment of medical expenses, the credit card number may be charged with the outstanding balance identified on the EOB. An exemplary process for applying electronic funds in accordance with some embodiments of the invention is described in more detail below.

As should be appreciated from the foregoing discussion, some embodiments of the invention are directed to methods and apparatus for processing pre-authorized payments for healthcare expenses in accordance with at least two generalized processes. In a first process, authorization and payment information are received from a patient at the time of service. The received information is securely stored for later use upon receipt of an EOB. In a second process, after an EOB is received and provided the authorization is still valid, the stored information is used to remit payment for an outstanding balance indicated on the EOB.

In some embodiments, a pre-authorized payment arrangement may be established separately or in conjunction with processing a payment at the time of service (e.g., during check-in or check-out at a medical practice). For example, a patient may be asked to remit a co-payment amount at the time of service. The amount of the co-payment may depend on the patient's particular healthcare plan and/or the type of medical services provided to the patient.

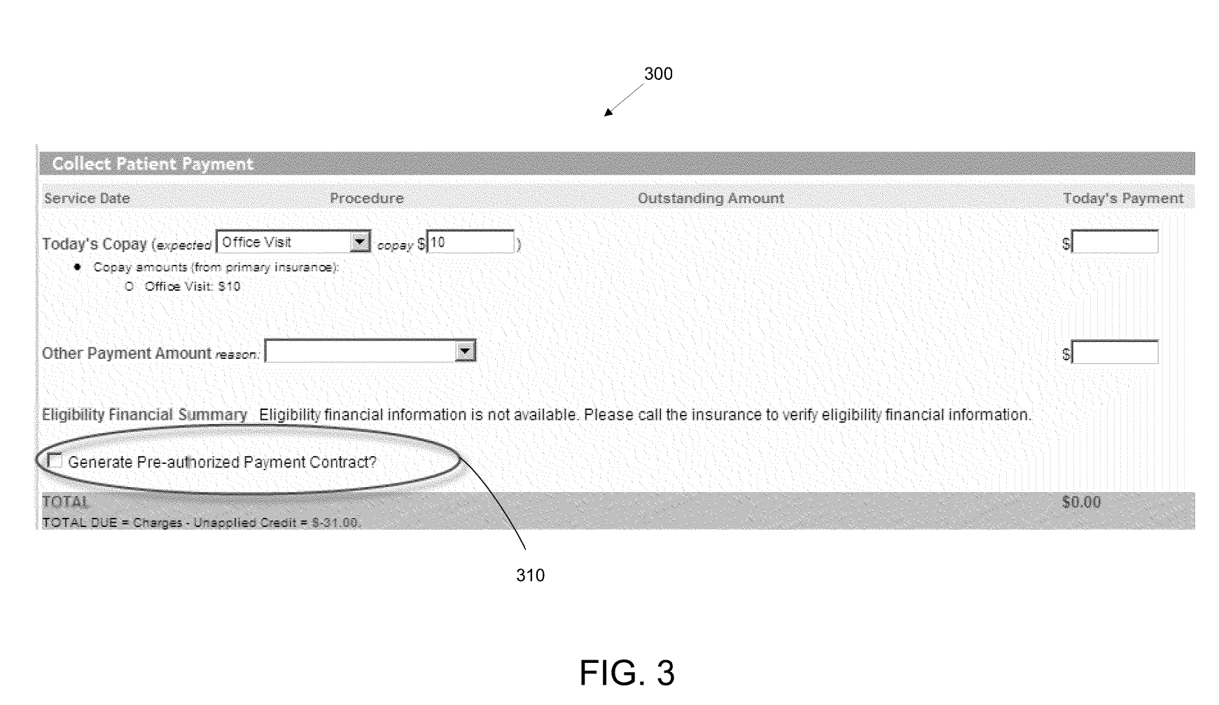

FIG. 3 illustrates an exemplary patient payment processing form 300 that may be presented as a portion of a user interface generated by a practice management system in accordance with some embodiments of the invention. Although exemplary patient payment processing form 300 is described in conjunction with processing a payment at the time of service, it should be appreciated that generating a pre-authorization payment arrangement may also be performed separately from processing a payment at the time of service and embodiments of the invention are not limited in this respect.

Administrative personnel at a medical practice may interact with payment processing form 300 to enter information regarding a payment type and/or amount that a patient is remitting to the medical practice at the time of service. Additionally, payment processing form 300 may include pre-authorized payment selector 310 that when selected initiates a process for generating a pre-authorized payment contract in accordance with some embodiments of the invention. In response to selecting pre-authorized payment selector 310, one or more additional fields may be created and/or activated to enable the administrative personnel at the medical practice to specify more information associated with the pre-authorized payment contract.

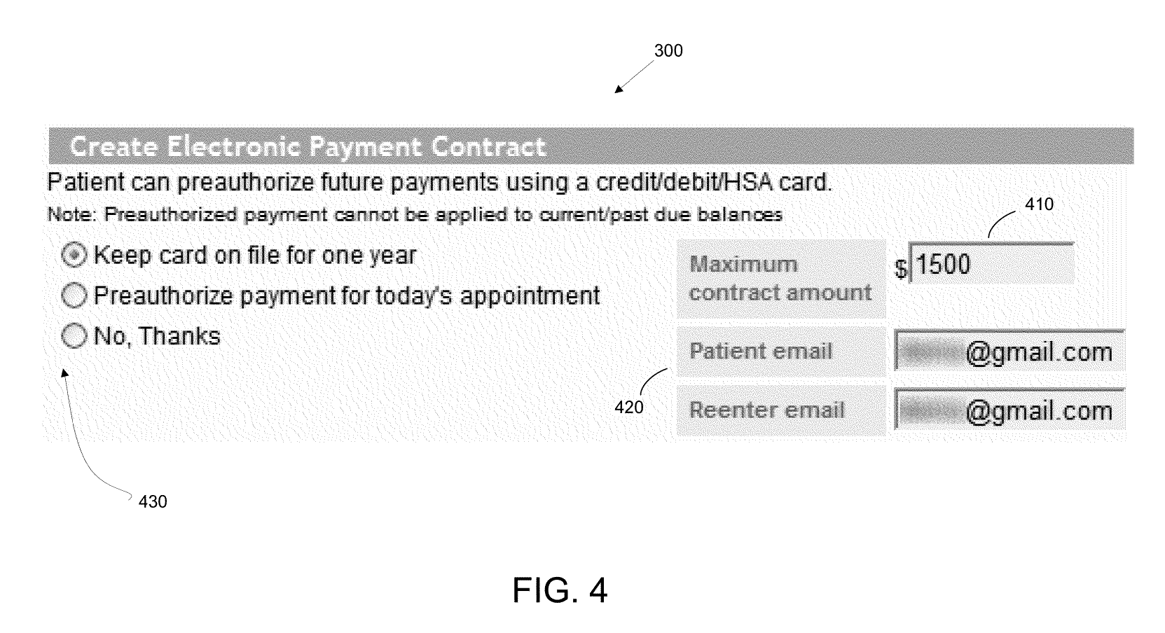

FIG. 4 illustrates a portion of exemplary payment processing form 300 after selection of pre-authorized payment selector 310. With the escalating costs of healthcare, and the reliance on some payers to shift the payment burden more on patients, some patients may be hesitant to engage in a contract with a medical practice for future payments without placing a maximum limit on the amount that can be charged to the provided electronic account. To mitigate these concerns, in some embodiments payment processing form 300 may include maximum amount field 410 that enables a patient to only authorize automatic payments up to a certain amount. Any suitable value may be entered in maximum amount field 410 and embodiments of the invention are not limited in this respect. In some embodiments, which support card-on-file contracts, discussed in more detail below, a patient may be able to specify a maximum limit for single-appointment contracts and a maximum limit for card-on-file contracts. For example, if the term for a card-on-file contract is one year, the patient may be more comfortable raising the maximum limit compared to a single-appointment contract where the costs for medical services are generally expected to be less.

Payment processing form 300 may also include one or more patient notification fields 420 for entering contact information for the patient. In the exemplary payment processing form 300, the contact information is an email address. However, it should be appreciated that any other suitable type of contact information such as a phone number or a mailing address may also be used. Additionally, in some embodiments, notification preference information may also be entered on exemplary payment processing form 300 and/or stored by a component of the practice management system. For example, the patient may specify contact information for email, home phone, mobile phone, and mailing address, although the patient may prefer to be contacted by email. To ensure that the notification information entered in patient notification field 420 is correct, administrative personnel at a medical practice may be prompted to enter the notification information more than once. For example, payment processing form 300 includes two fields for entering email information and if the email information entered in the two fields is not the same, the user interface may display an error message warning the user that a mistake may have been made in entering the notification information.

Payment processing form 300 may also include term selector 430 that enables a patient to specify whether they would like to keep the card on file for a particular amount of time (e.g., one year). If this option is selected, the patient may pre-authorize all payments during that time. Alternatively, the patient may choose to only pre-authorize payments associated with the medical services associated with the current appointment. Contracts associated with multiple appointments are referred to herein as “card-on-file” contracts, whereas contracts associated with a single appointment are referred to herein as “single-appointment” contracts. In some embodiments, a single appointment contract may not be established if the patient already has a valid card-on-file contract.

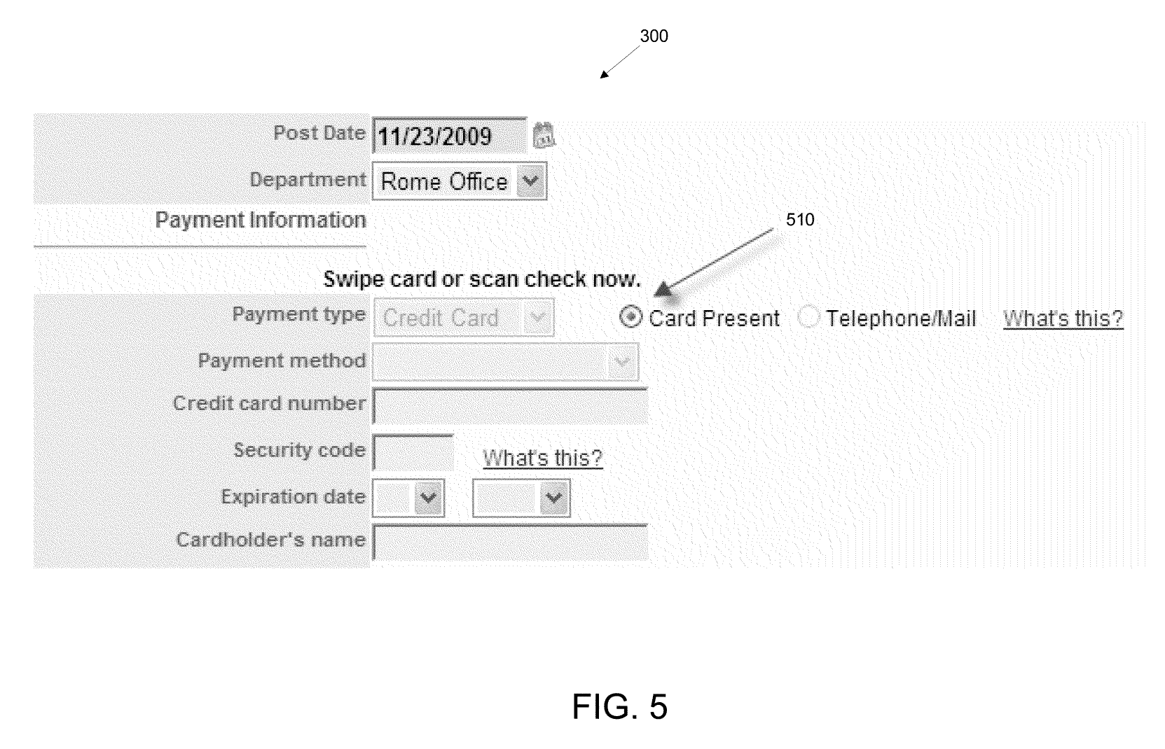

FIG. 5 illustrates an electronic account information portion of payment processing form 300 in accordance with some embodiments of the invention. As discussed above, in some embodiments, electronic account information may be automatically collected based on a patient action such as swiping an electronic card through a card reader connected to a computer at the medical practice. However, electronic account information may also be manually entered by administrative personnel at the medical practice and embodiments of the invention are not limited in this respect. Payment processing form 300 may include card present selector 510 to enable a user to specify that the patient would like to use a card that they have with them to enter the electronic account information. If the patient would like to use a particular card for future payments, but does not have it with them, the patient may be able to provide the electronic account information for the particular card to the medical practice via some other method (e.g., via phone, mail, or fax).

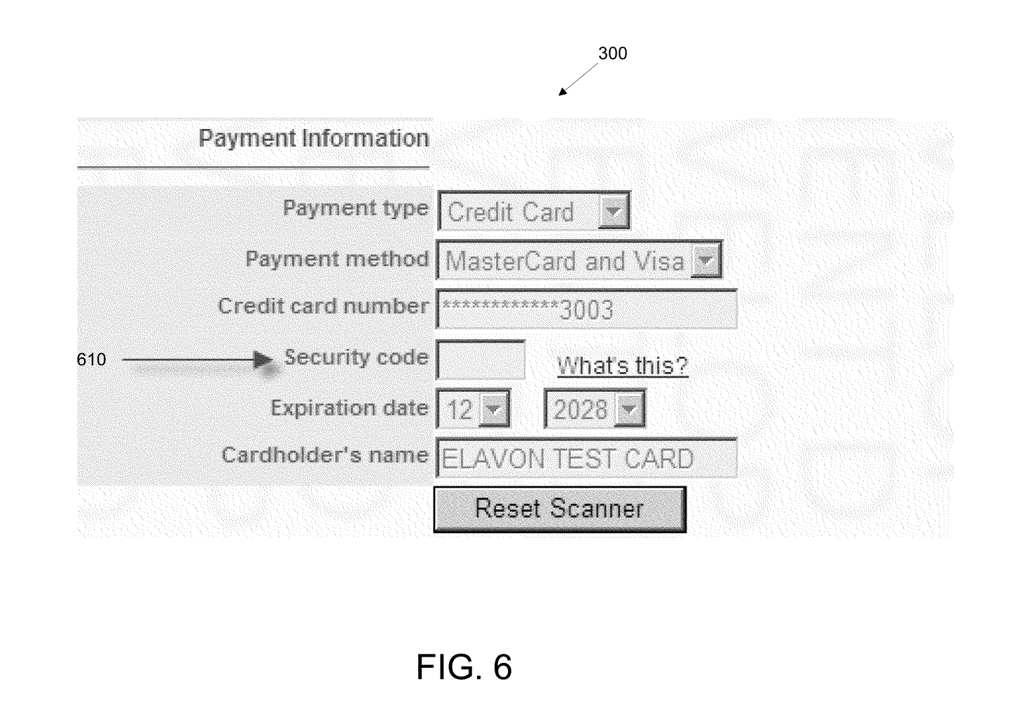

A payment portion of payment processing form 300 may include a plurality of fields for entering electronic account information such as payment type, payment method, card identifier, security code, expiration date, and other cardholder information including name and billing address. FIG. 6 illustrates exemplary payment processing form 300 after a patient has swiped a credit card resulting in electronic account information being transferred from the card reader to payment processing form 300. Although exemplary payment processing form 300 is illustrated with respect to using a credit card as the payment type, it should be appreciated that any other suitable form of payment may also be used including, but not limited to, a debit card, direct withdrawal from a bank account, withdrawal from a health savings account, and withdrawal from a flexible spending account.

Depending on the particular type of payment chosen, the fields displayed in the payment portion of payment processing form 300 may change and embodiments of the invention are not limited in this respect. For example, as shown in FIG. 6, when credit card is selected as the payment type, a user may be prompted to enter security code 610 associated with the credit card to ensure proper processing of transactions involving the credit card. However, other payment types may not prompt a user to enter security code 610 and/or may prompt the user for other information germane to processing payments using the selected form of payment.

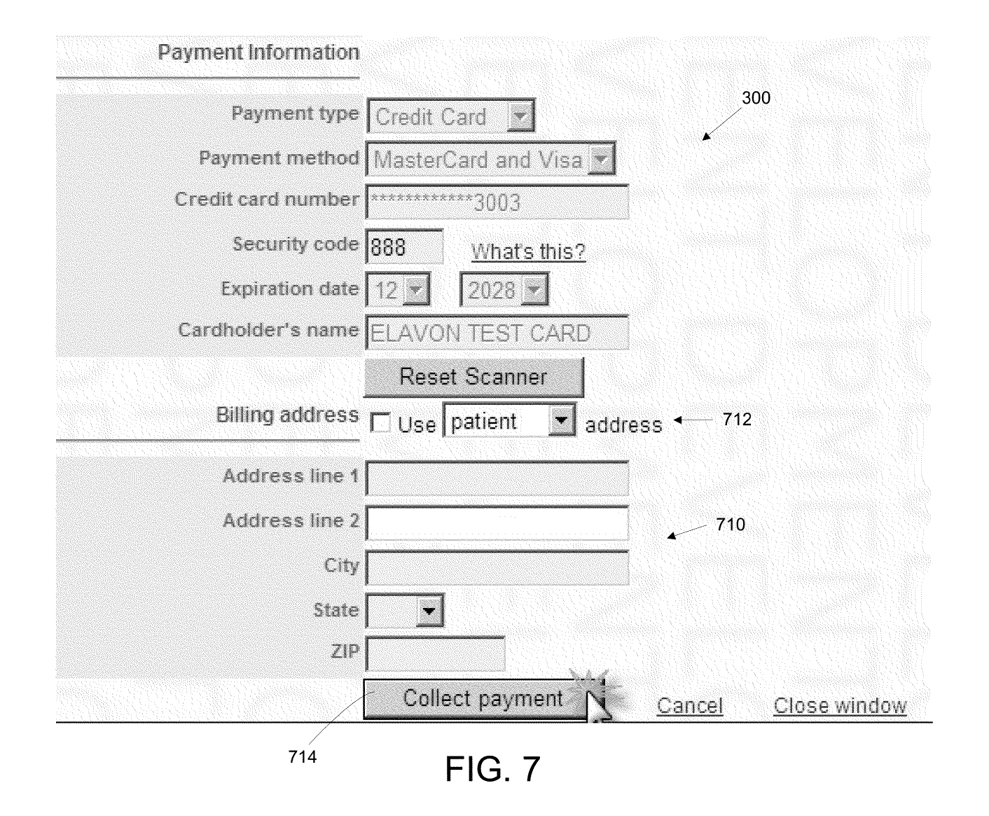

FIG. 7 illustrates a billing address portion 710 of payment processing form 300. Payment transactions often require the billing address of the account holder to be entered to prevent fraudulent use of the account. In some embodiments of the invention patient address information may be stored by a component of the practice management system and administrative personnel may select patient address selector 712 to populate one or more fields in billing address portion 710 based on the stored patient information. However, it should be appreciated that the one or more fields in billing address portion 710 may also be filled in manually and embodiments of the invention are not limited in this respect. After a user at the medical practice has finished entering patient and payment information, the user may select collect payment selector 714 to generate a pre-authorized payment contract based, at least in part, on the information included in payment processing form 300.

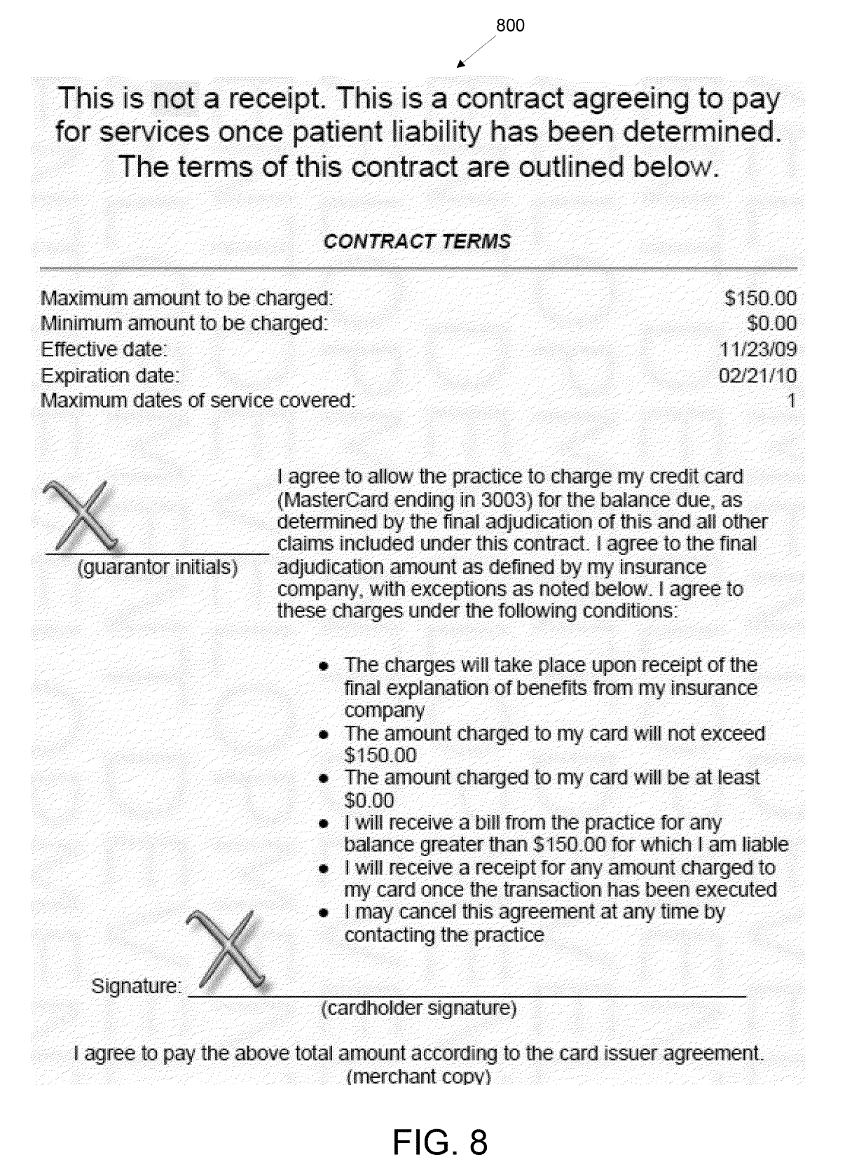

FIG. 8 illustrates an exemplary pre-authorized payment contract 800 generated in accordance with some embodiments of the invention. Contract 800 may include terms and conditions to which the patient must agree prior to the contract becoming effective. For example, contract 800 may include the maximum charge amount, the term of the contract, the number of patient visits covered by the contract, and any other information related to processing future payments including, but not limited to, the payment type. The patient may execute the contract by signing the contract and the medical practice may keep on file a copy of the contract for at least the term of the contract, or as applicable law requires.

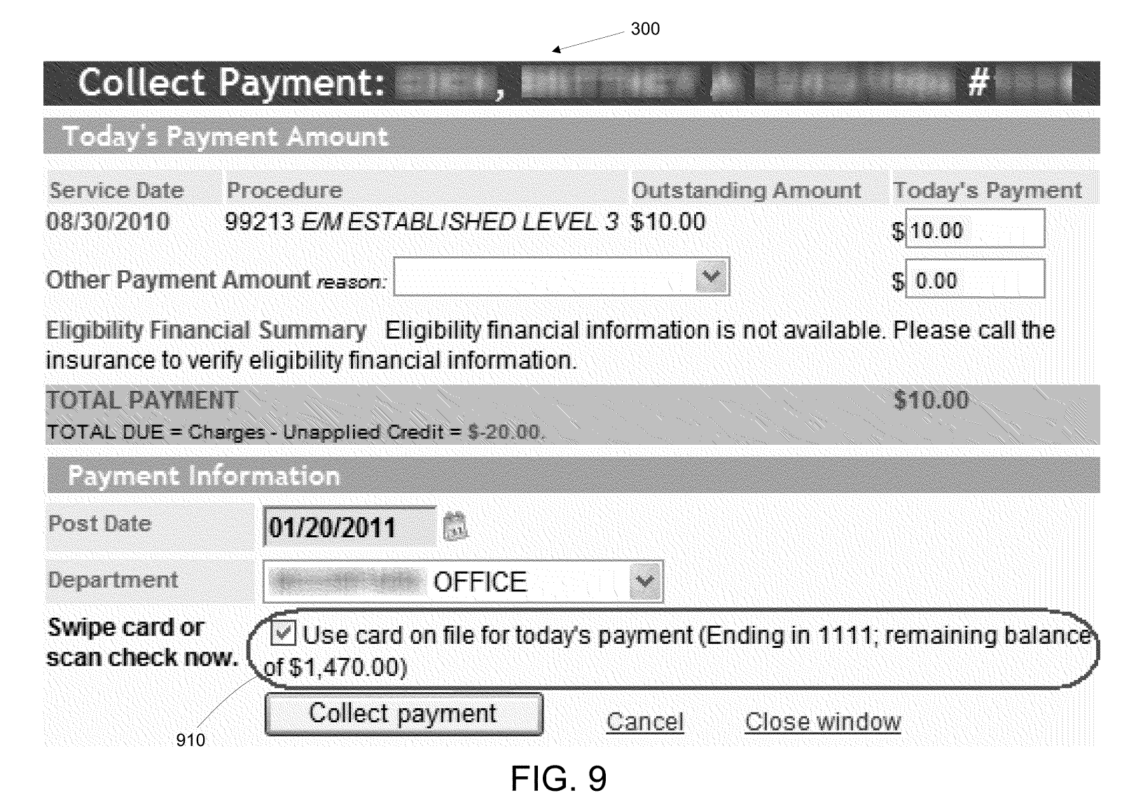

FIG. 9 illustrates an alternative payment portion of payment processing form 300 for which the patient has a card on file and would like to use the card on file to authorize a payment. Because the card information was previously entered and stored, the patient may not have to swipe their card though a card reader to authorize the payment transaction. Rather, the patient may inform administrative personnel at the medical practice that the patient would like to use the card on file and the administrative personnel may interact with payment processing form 300 to select use card on file selector 910.

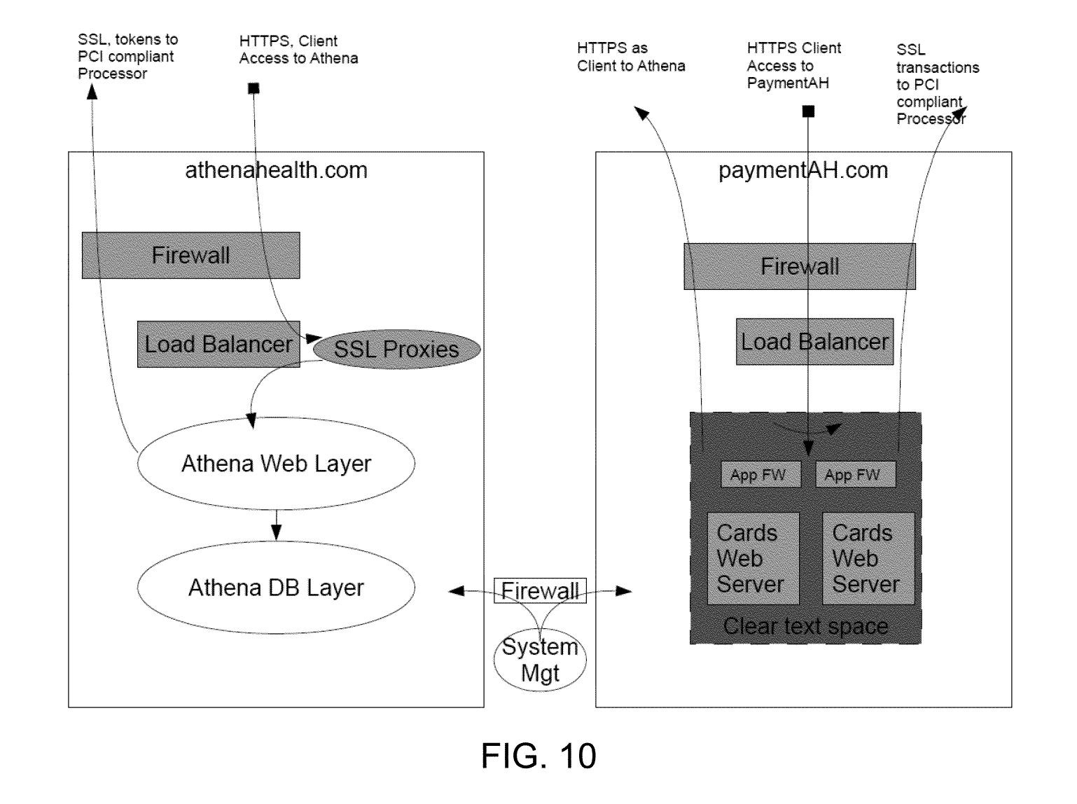

Some embodiments of the invention are directed to integrating a pre-authorized payment system with a healthcare billing component of a practice management system. However, due to the sensitive nature of electronic account information, some embodiments are directed to isolating critical card data, such as account numbers, track data, and CVV data from the practice management system to ensure that the practice management system is not within the scope of a payment card industry (PCI) audit. FIG. 10 illustrates a block diagram of an architecture for an exemplary payment processing application executing on a secure server for use with some embodiments of the invention. Although the individual components in block diagram illustrated in FIG. 10 are not described in detail herein, some embodiments of the invention may use one or more components of such an architecture to process pre-authorized payments as described herein. A payment processing application may be used to isolate critical card information from the practice management system to achieve one or more security goals. For example, this may be performed by restricting critical card data flow only through the payment processing application. Accordingly, rather than storing electronic account information within a component of the practice management system, some embodiments of the invention transfer electronic card information directly to a secure server. In response, the secure server may send the practice management system a token to associate with patient information stored on the practice management system to enable pre-authorized transactions to be processed in accordance with some embodiments of the invention.

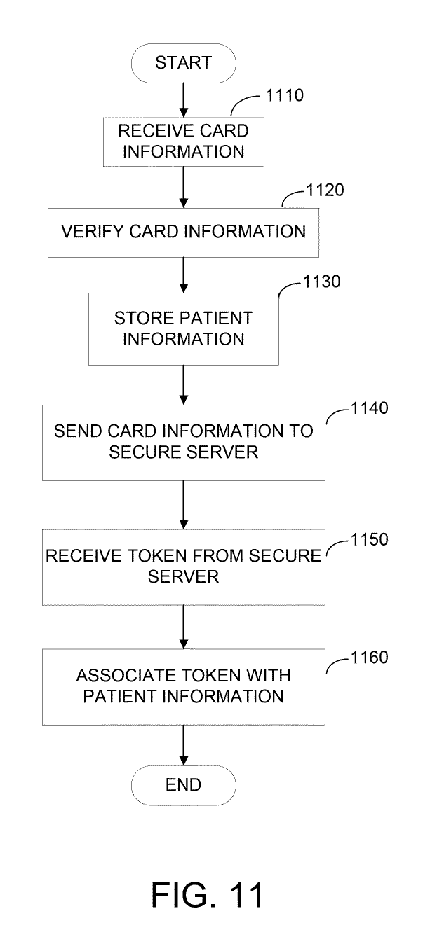

FIG. 11 illustrates a flow chart of a process for securely storing electronic account information in accordance with some embodiments of the invention. In act 1110 card information is received from a patient. For example, as described above, during a patient visit the patient may authorize future payments for medical services and the patient may swipe an electronic card through a card reader connected to a computer at the medical practice. After the card information is received, the process proceeds to act 1120 where the card information is verified. The card information may be verified in any suitable way and embodiments of the invention are not limited in this respect. For example, administrative personnel at the medical practice may check at least some of the card information transferred from the card reader with the information displayed on the actual card. Depending on the type of card used, the administrative personnel may also enter other information such as a security code, which enables a payment processing application to verify the identity of the card information.

The process then proceeds to act 1130 where patient information is stored by the practice management system. Patient information may include, but is not limited to, contact information, a copy of an authorization contract, contract terms, or any other patient information. As described above, some embodiments of the invention are directed to isolating critical card data from components of the practice management system. To this end, card information may not be stored by the practice management system. Rather, the process proceeds to act 1140 where the card information is sent to a secure server. The secure server may include one or more payment processing applications executing thereon to facilitate processing of pre-authorized payments in accordance with embodiments of the invention. The process then proceeds to act 1150 where a token is received from the secure server indicating that the card information is stored on the secure server and associating the card information with the token. After the token is received, the process proceeds to act 1160 where the token is associated with the patient information stored by the practice management system. As described in more detail below, upon receipt of an EOB, the token associated with the patient information is sent to the payment processing program executing on the secure server which uses the token to identify the associated card information for the patient for payment processing.

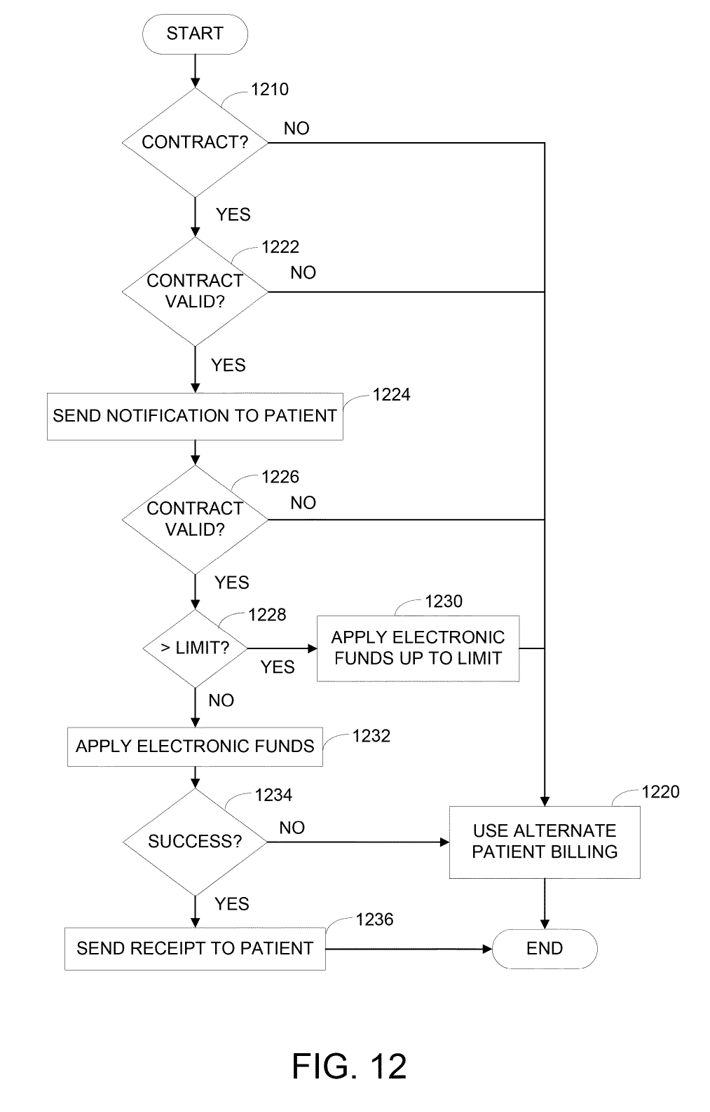

After collecting and storing payment and patient information at the time of service, the stored information may be used when an EOB is received to automatically remit payment to a medical practice for the outstanding balance indicated on the EOB. FIG. 12 illustrates a flow chart of a process for processing a pre-authorized payment in response to receiving an EOB in accordance with some embodiments of the invention. Once one or more claims for a patient have been fully adjudicated by a healthcare payer, the payer may inform the practice management system that an EOB is available for the submitted claims and the EOB may identify an outstanding balance for which the patient is responsible for paying.

In response to determining that an EOB has been received, in act 1210, it is determined whether the patient associated with the EOB has a pre-authorized payment arrangement (e.g., a contract) with the medical practice stored by the practice management system. If it is determined that the patient does not have a pre-authorized payment arrangement, the process proceeds to act 1220 where an alternate patient billing method is used to bill the patient. For example, the patient may be sent an electronic or paper statement detailing the outstanding charges and providing instructions for remitting payment to the medical practice. However, if it is determined in act 1210 that a pre-authorized payment arrangement exists, the process proceeds to act 1222 where it is determined whether the contract is still valid. As described above, in some embodiments a patient may cancel a contract at any point by contacting the medical practice and requesting that the contract be canceled. Accordingly, because receiving an EOB from a healthcare payer may take time, it is determined if the patient has canceled the contract in the interim. Alternatively, the contract could have been specified with a particular term and depending on when the EOB is received, the contract may no longer be valid.

If it is determined that the contract is no longer valid the process proceeds to act 1220 where an alternate patient billing method is used to inform the patient of the outstanding balance. However, if it is determined in act 1222 that the contract is valid, the process proceeds to act 1224 where a notification is sent to the patient using notification information stored by the practice management system. For example, if the patient provided email information when the contract was established, the patient may be sent an email notification that includes information about the outstanding balance and that the balance will be charged to the electronic account specified in the contract. In some embodiments the notification may be sent a particular amount of time (e.g., a few days) prior to a scheduled payment transaction to provide the patient with enough time to cancel the contract if so desired. The notification may include any suitable information to inform the patient of the scheduled payment transaction including, but not limited to, the amount of the outstanding balance and the scheduled date for the payment transaction.

After the notification is sent to the patient and after a particular amount of time has elapsed, the process proceeds to act 1226 where it is determined if the contract is still valid. As discussed above, a notification may be provided to the patient to enable the patient to cancel the contract prior to the scheduled date for the payment transaction if so desired. Accordingly, prior to initiating the payment transaction, it is determined whether the contract is still valid. If it is determined in act 1226 that the contract is not valid, the process proceeds to act 1220 where an alternate patient billing process is used to inform the patient about the outstanding balance. However, if it is determined in act 1226 that the contract is valid, the process proceeds to act 1228 where it is determined whether the outstanding balance exceeds a maximum payment limit specified in the contract.

If it is determined in act 1228 that the limit is exceeded, the process proceeds to act 1230 where a payment transaction is executed for the amount of the outstanding balance up to the maximum limit. After the payment transaction is completed, the process proceeds to act 1220 where an alternate patient billing method is used to inform the patient about the remaining outstanding balance due. If it is determined in act 1228 that the limit is not exceeded, the process proceeds to act 1232 where a payment transaction is executed for the entire amount of the outstanding balance.

After the payment transaction is completed, the process proceeds to act 1234 where it is determined whether the payment transaction was successful. If it is determined in act 1234 that the payment transaction was not successful, the process proceeds to act 1220 where an alternate patient billing process is used to inform the patient about the outstanding balance. For example, the card on file may have been canceled between the time when the card information was provided during the time of service to the time when the payment transaction was initiated. Alternatively, when the payment transaction was attempted, it may have been determined that the card limit had been reached thereby resulting in an unsuccessful payment transaction. Other reasons for an unsuccessful payment transaction are also possible, but are not explained here for brevity. Additionally, in some embodiments in which the payment transaction was not successful, the patient may be sent a notification that the pre-authorized payment transaction was not successful and that the patient will be receiving a bill for outstanding balance.

If it is determined in act 1234 that the pre-authorized payment transaction was successful, the process proceeds to act 1236 where a receipt is sent to the patient indicating that the transaction was successful. The receipt may be sent to the patient in any suitable way. For example, the receipt may be sent using notification information and/or one or more communication parameters stored by the practice management system. The particular manner in which the receipt is sent to the patient is not a limiting aspect of embodiments of the invention. In some embodiments, a copy of some or all of the notifications and/or receipts may be sent to the medical practice associated with the EOB.

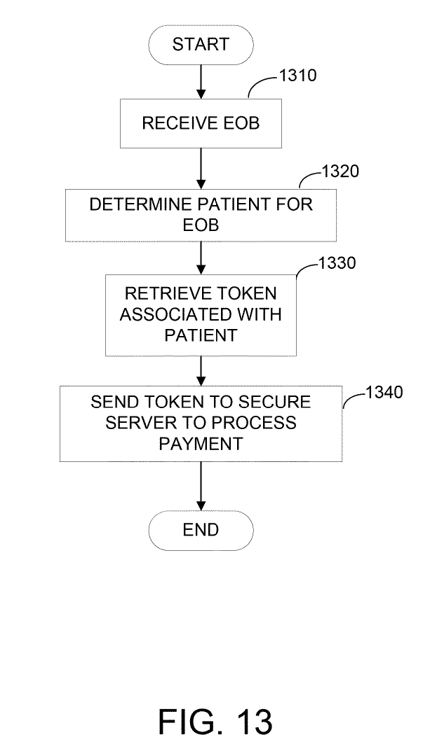

FIG. 13 illustrates a flow chart of a process for performing a pre-authorized payment transaction in accordance with some embodiments of the invention. In act 1310 an EOB or an equivalent indication of an EOB is received by a component of the practice management system. At this point, the patient liability is known and the patient can be billed accordingly. The process then proceeds to act 1320 where the patient associated with the EOB is determined. Determining the patient associated with the EOB may be performed in any suitable way. For example, the payer sending the EOB may identify to the practice management system the identity of the patient associated with the EOB. Alternatively, information in the EOB may be analyzed to determine the identity of the patient associated with the EOB.

After the patient associated with the EOB is identified, the process proceeds to act 1330 where a token associated with the patient information is retrieved. As discussed above, some embodiments of the invention are directed to isolating critical card information from the practice management system. Accordingly, the card information may be stored on a secure server and the secure server may return a token to the practice management system which maps the patient to the card information stored on the secure server. The practice management system may then store the token rather than the card information. In response to retrieving the token for the patient associated with the EOB, the process proceeds to act 1340 where the token is sent to the secure server to process the payment transaction as described above.

The inventors have recognized and appreciated that after receiving an EOB from a healthcare payer, in some instances the healthcare payer may send a readjudicated EOB in which the outstanding balance for which the patient is responsible has changed from the previous EOB. However, the costs associated with crediting a patient if the new outstanding balance is less than the previous balance or charging the patient a second time based on the new EOB are usually substantial. Some embodiments of the invention facilitate processing adjustments based on a readjudicated EOB by automatically applying the difference in outstanding balance to a card on file without user intervention.

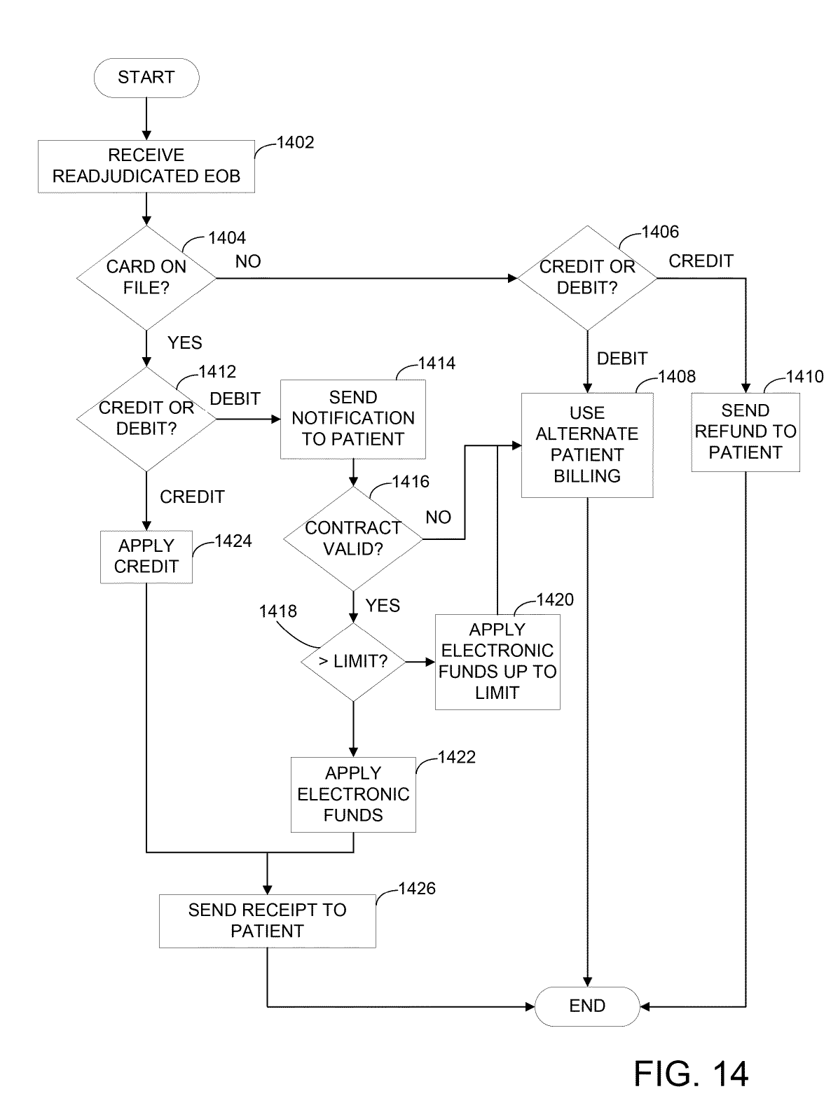

FIG. 14 illustrates a process for processing a readjudicated EOB in accordance with some embodiments of the invention. In act 1402 a readjudicated EOB is received. The patient associated with the readjudicated EOB may be identified and the process proceeds to act 1404 where it is determined whether the patient has a card on file. If it is determined in act 1404 that there is not a card on file, the process proceeds to act 1406 where it is determined whether the outstanding balance indicated on the readjudicated EOB is more or less than the outstanding balance on the previous EOB.

If it is determined in act 1406 that the new outstanding balance is less than the previous balance, the process proceeds to act 1410 where a refund is sent to the patient. In some embodiments, rather than sending a refund to the patient, the medical practice may credit a patient's account and use the credit for payment of future medical services provided by the medical practice. If it is determined in act 1406 that the new outstanding balance is more than the previous balance, the process proceeds to act 1408 where an alternate patient billing method is used to inform the patient of the outstanding balance. For example, the patient may be sent an electronic or paper statement indicating the outstanding balance and instructions to remit the outstanding balance to the medical practice.

However, if it is determined in act 1404 that the patient does have a card on file, the process proceeds to act 1412 where it is determined whether the outstanding balance indicated on the readjudicated EOB is more or less than the outstanding balance on the previous EOB. If it is determined in act 1412 that the new balance is less than the previous balance, the process proceeds to act 1424 where a credit is applied to the balance on the card on file. After the credit has been applied, the process proceeds to act 1426 where a receipt is sent to the patient to inform the patient that the card on file has been credited.

If it is determined in act 1412 that the new balance is more than the previous balance, the process proceeds to act 1414 where a notification is sent to the patient regarding the new charges. The notification may be provided to the patient in any suitable way including, but not limited to, using notification provided when the contract was created. The process then proceeds to act 1416 where it is determined if the contract is still valid. As described above, one potential consequence of notifying a patient about a scheduled payment transaction is the possibility that the patient will inform the medical practice to cancel the contract. If it is determined in act 1416 that the contract is not valid, the process proceeds to act 1408 where an alternate patient payment billing method is used to inform the patient about the outstanding balance.

If it is determined in act 1416 that the contract is valid, the process proceeds to act 1418 where it is determined whether the new charges exceed the maximum limit associated with the contract. If it is determined in act 1418 that the new charges exceed the limit, the process proceeds to act 1420 where the card on file is charged up to the maximum limit. The process then proceeds to act 1408 where the remaining charges are billed to the patient using an alternate billing method such as by sending the patient an electronic or paper statement. If it is determined in act 1418 that the new charges do not exceed the maximum limit associated with the contract, the process proceeds to act 1422 where the card on file is charged for the entire amount of the new charges. The process proceeds to act 1426 where a receipt detailing the charges applied to the card on file is sent to the patient.

Although only a few exemplary scenarios have been described in which embodiments of the invention may be used to provide an efficient patient payment processing system, it should be appreciated that some embodiments of the invention may be used in any other suitable scenario in which using pre-authorized payment information would be advantageous and embodiments of the invention are not limited in this respect.

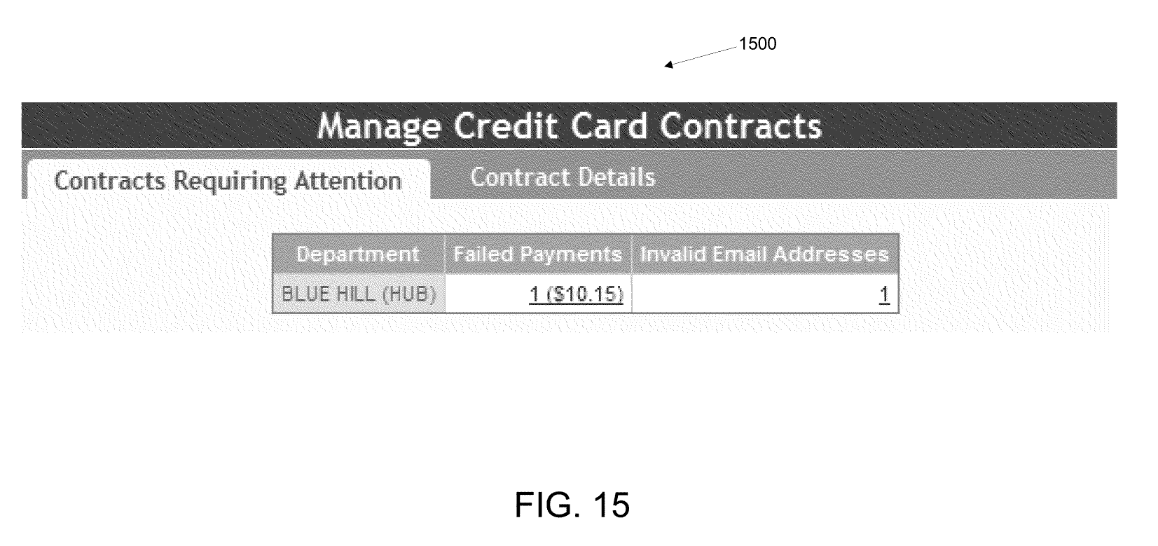

Some embodiments are directed to enabling users of a practice management system to manage one or more contracts established between a patient and the user's medical practice. FIG. 15 illustrates an exemplary contract management page 1500 displayed as a portion of a user interface that a user such as a billing administrator at a medical practice may interact with to manage contracts between patients and the medical practice. Although the user may not wish to alter the terms of the contract, as such alterations may require new authorization by the patient, certain aspects of contract information may be altered in accordance with some embodiments of the invention to facilitate a pre-authorization patient payment process as described herein.

Common difficulties with contracts maintained by the practice management system include, but are not limited to, failed payments and invalid notification information. A user at a medical practice may periodically check contract management page 1500 to determine the number of patients with contracts that require attention. A failed payment event may occur when the practice management system attempts to charge a credit card according to an existing electronic payment contract and the transaction fails. When the transaction fails, the practice management system may, among other things, send a failure notification to the patient, cancel the electronic payment contract, send the patient a statement indicating the outstanding balance, and provide an indication to a user of the medical practice that the payment failed and the contract requires attention.

Another potential difficulty is invalid notification information. When the practice management system attempts to send an automated payment notification or receipt to a patient, an error message may be encountered indicating that the notification information on file is not valid. For example, if the notification information is an email address, notifications or receipts sent to the email address on file may not be rejected resulting in the patient not receiving the intended message. The practice management system may also keep track of instances of invalid notification events and may, among other things, provide an indication to a user of the medical practice that the contract requires attention. Although only difficulties with failed payments and invalid notification information are described herein, it should be appreciated that other difficulties with contracts may also arise and such difficulties may be indicated on contract management page 1500 as embodiments of the invention are not limited by the particular type and number of contract difficulties displayed on contract management page 1500.

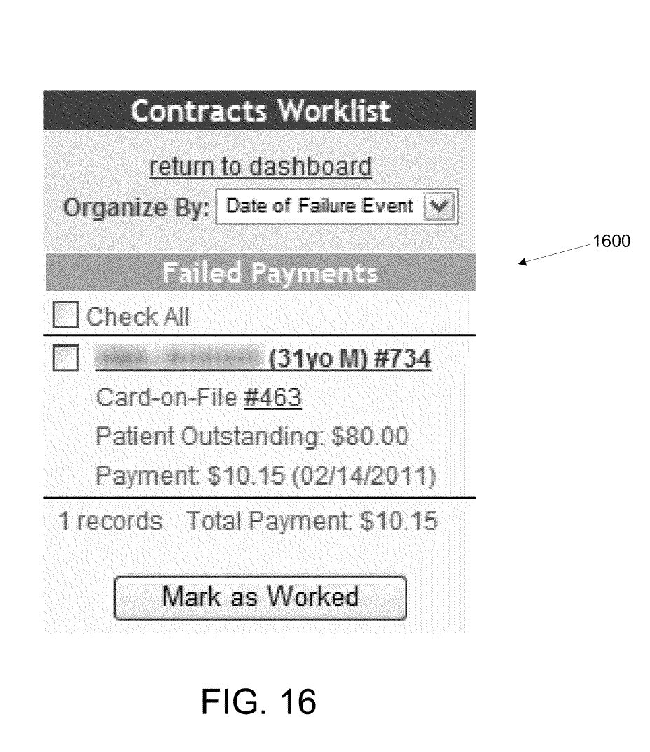

A user at a medical practice may interact with contract management page 1500 to resolve one or more difficulties displayed thereon. For example, in response to interacting with a failed payments selector on contract management page 1500, the user interface may display failed payment page 1600 as shown in FIG. 16. The user may then retrieve the patient's information and call the patient to process the outstanding payment over the phone. The user may also inform the patient that although the patient may receive a statement due to the failed payment, the patient should not pay the outstanding balance a second time. The user may additionally make a note to create a new contract when the patient visits the office again, as it may be required that the patient be present to establish a new contract.

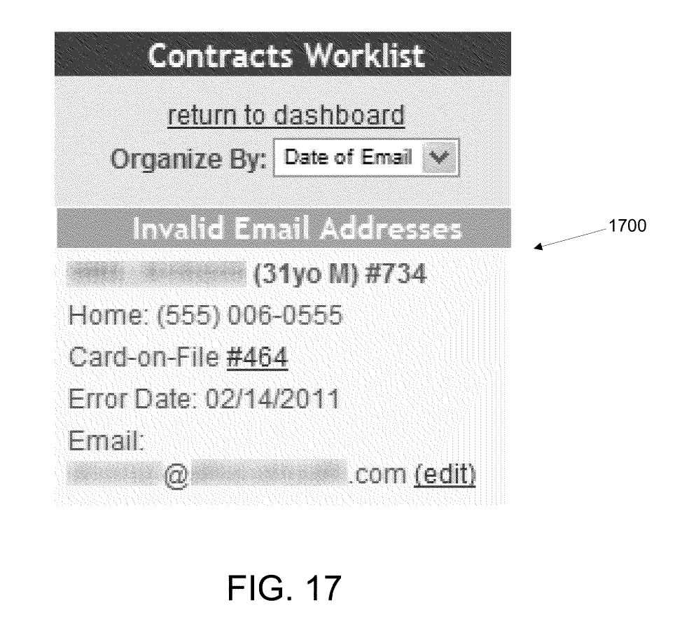

A user may also interact with an invalid notification selector displayed on contract management page 1500 to update the patient's notification information. For example, in response to interacting with an invalid notification selector, the user interface may display invalid notification page 1700 as shown in FIG. 17. The user may access the patient's contact information to call the patient to determine valid notification information such as a valid email address. The valid email address may then be updated and associated with the existing contract. In some embodiments, updating notification information such as an email address may not automatically send the original notification or receipt to the new valid email address. However, in other embodiments, failed notifications and/or receipts may be stored in a queue on the practice management system and when a new valid email address is updated and associated with a patient's contract, any queued messages may be sent to the patient at the new valid email address.

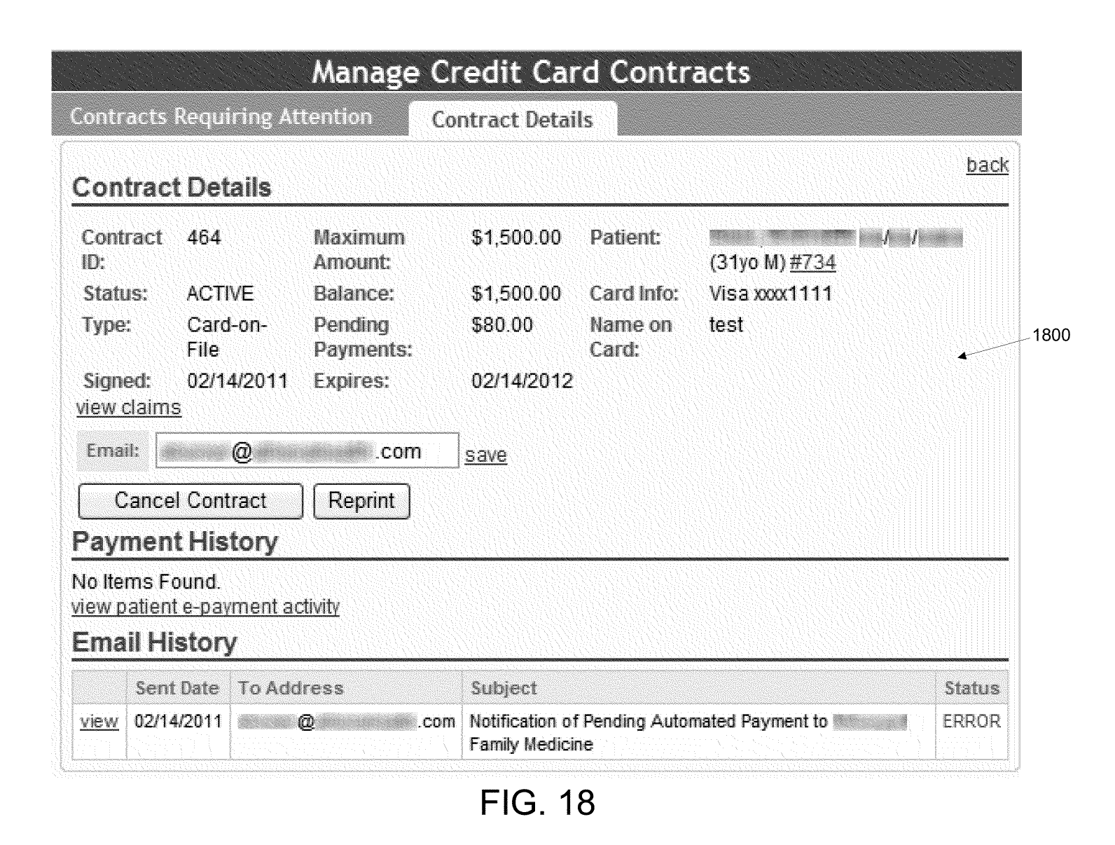

In some embodiments, users of the practice management system may review one or more electronic payment contracts between patients and the users' medical practice by interacting with a contract details selector displayed on contract management page 1500. For example, in response to interacting with a contract details selector, the user interface may display contract details page 1800 as shown in FIG. 18. The user may interact with one or more selectors or fields displayed on contract details page 1800 to perform one or more actions related to the contract. For example, the user may reprint the contract, cancel the contract, or review information about the contract including the current balance, pending payments, and expiration date of the contract.

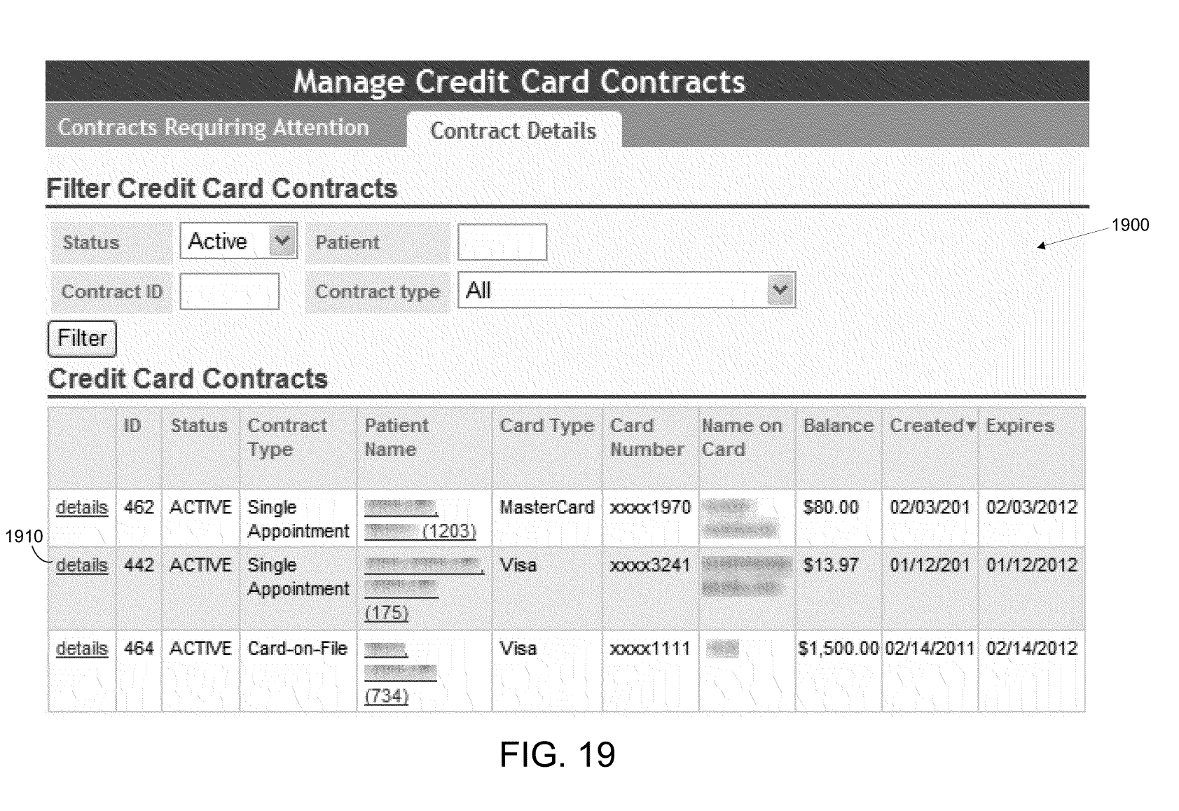

FIG. 19 illustrates an alternate view of contract details page 1800. As illustrated in FIG. 19, a user may interact with contract details page 1800 to search for contracts that satisfy search criteria entered by the user. The filtered results generated in response to a search and displayed on contracts details page 1800 may include details selector 1910 that when selected by a user enables the user to view details for the selected contract as shown in FIG. 18.

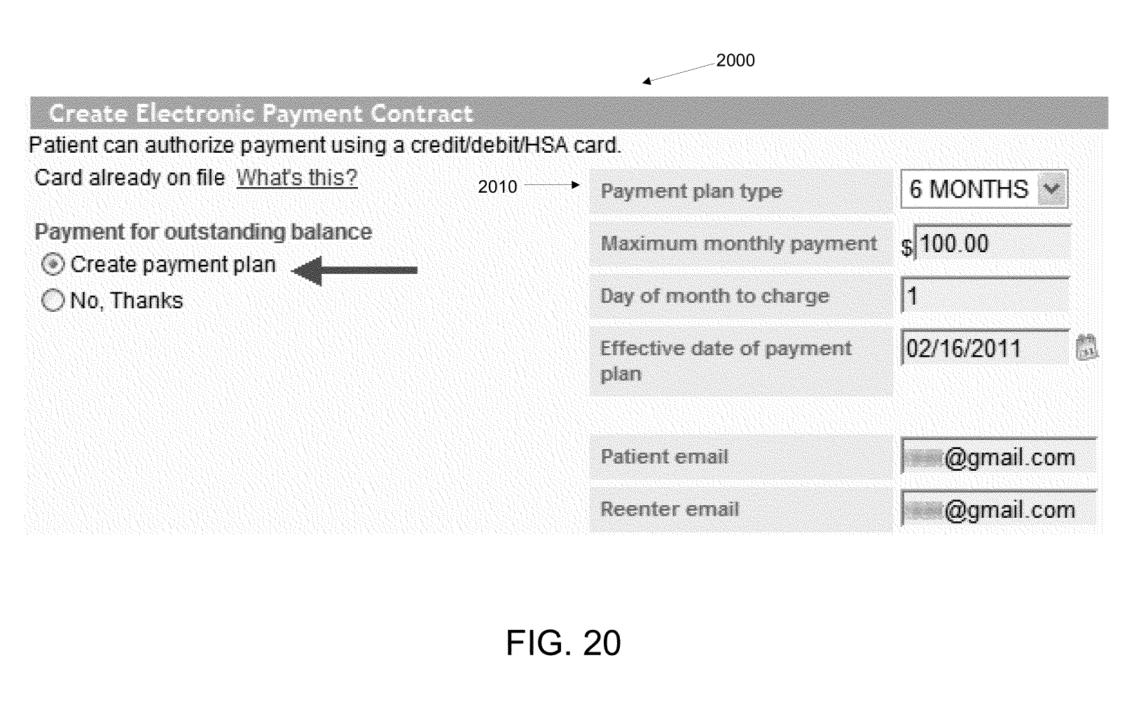

In some embodiments, administrative personnel at a medical practice may establish an electronic payment plan with a patient to enable the practice to charge (or debit) the patient's card for a fixed amount each month until the patient's entire balance is paid. FIG. 20 illustrates an exemplary payment plan page 2000 in accordance with some embodiments of the invention. An authorized user, such as billing administrator may interact with payment plan page 2000 to specify criteria for the electronic payment plan. For example, the user may interact with payment type selector 2010 to select a duration for the payment plan. The user may also interact with other fields or selectors to specify the terms of the payment plan including the maximum monthly charge and the day of the month to process the charge transaction. As with other contracts, the patient may be required to be present when a new electronic payment plan is established because the patient may need to authorize the terms of the electronic payment plan. In some embodiments an electronic payment plan may be created for all of a patient's outstanding balance or only a portion of the outstanding balance and embodiments of the invention are not limited in this respect.

In some embodiments, electronic payment plans may be created that cover medical expenses incurred by more than one patient. For example, family members may create an electronic payment plan in which the shared outstanding balance is managed through the shared plan.

In some embodiments, a card-on-file contract may be created that covers medical expenses incurred by more than one patient. For example, family members may create a single card-on-file contract that covers all future claims for all members of the family. Family members may be added or removed from the contract and claims associated with the added or removed family members may be billed accordingly. In some embodiments, one member of the family may originate the contract and this patient may be known as the contract originator. In one embodiment, if the contract originator is removed, the contract may move with the removed family member. That is, the practice management system may remove from the contract all claims for all other family members other than the contract originator.

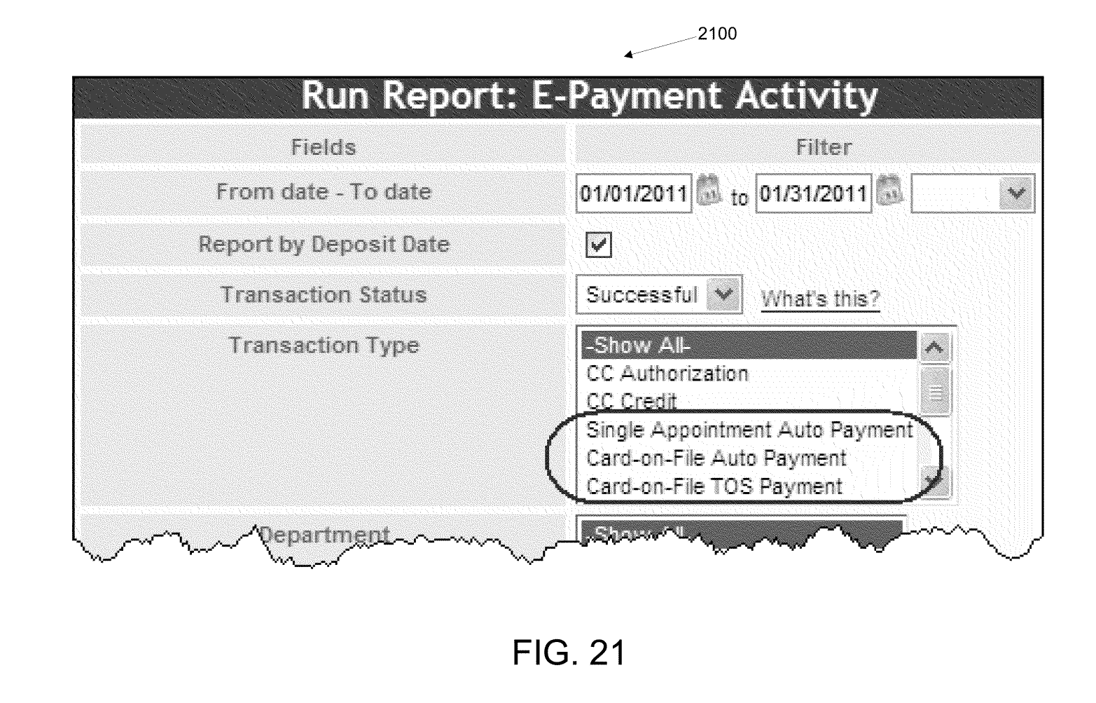

Some embodiments are directed to enabling a user at a medical practice to generate one or more reports detailing electronic payment activity. FIG. 21 illustrates an exemplary electronic report generation page 2100 for a medical practice. By interacting with one or more fields and/or indicators on electronic report generation page 2100, a user may view patient payment activity across some or all patients associated with the medical practice.

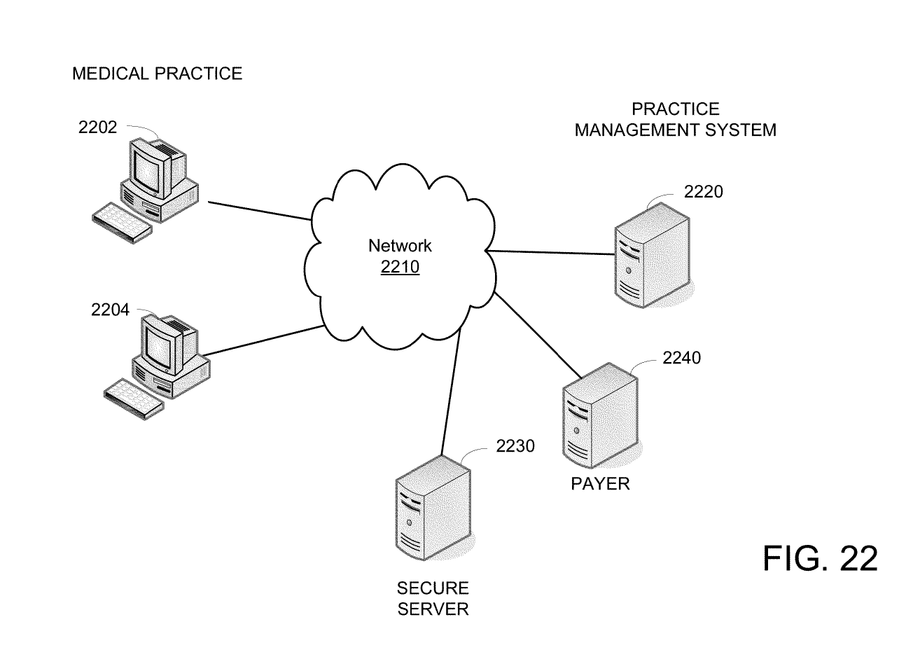

FIG. 22 illustrates an exemplary networked system on which some embodiments of the invention may be employed. Networked computers 2202 and 2204 located at a medical practice, secure server 2230, healthcare payer computer 2240, and computer 2220 located at a location associated with a practice management system are shown connected to a network 2210. Network 2210 may be any type of local or remote network including, for example, a local area network (LAN) or a wide area network (WAN) such as the Internet. In the example of FIG. 22, five networked computers are shown. However, it should be appreciated that network 2210 may interconnect any number of computers of various types and the networked system of FIG. 22 is provided merely for illustrative purposes. For example, computer 2220 may be connected via network 2210 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of processing healthcare payments, the method comprising:
receiving from a healthcare payer, an indication of an outstanding balance for a medical claim submitted to the healthcare payer on behalf of a medical practice;
identifying a patient associated with the medical claim;
determining whether the identified patient is associated with a pre-authorized payment contract; and
applying based, at least in part, on one or more payment terms in the pre-authorized payment contract, electronic funds to at least a portion of the outstanding balance for the medical claim in response to determining that the identified patient is associated with a pre-authorized payment contract.

2. The method of claim 1, wherein applying electronic funds to at least a portion of the outstanding balance comprises applying electronic funds to the entire outstanding balance.

3. The method of claim 1, further comprising:
determining that the outstanding balance is greater than a maximum amount specified in the pre-authorized payment contract; and
wherein applying electronic funds to at least a portion of the outstanding balance comprises applying electronic funds corresponding to the maximum amount specified in the pre-authorized payment contract to the outstanding balance.

4. The method of claim 1, further comprising:
determining whether the pre-authorized payment contract is valid prior to applying electronic funds to at least a portion of the outstanding balance; and
applying the electronic funds to at least a portion of the outstanding balance in response to determining that the pre-authorized payment contract is valid.

5. The method of claim 4, wherein determining whether the pre-authorized payment contract is valid comprises determining whether a contract duration associated with the pre-authorized payment contract has expired and/or determining whether an authorized party has canceled the contract.

6. The method of claim 4, further comprising:
generating one or more automated messages in response to determining the pre-authorized contract is not valid, wherein the one or more automated messages comprise instructions regarding payment of the outstanding balance; and
transmitting the one or more automated messages to the patient associated with the medical claim.

7. The method of claim 1, wherein the indication of an outstanding balance is provided in an explanation of benefits communication received from the healthcare payer.

8. The method of claim 1, further comprising:
receiving from the healthcare payer, a readjudicated claim including updated payment information for the medical claim; and
crediting or debiting an electronic account for the patient based, at least in part, on the updated payment information in the readjudicated claim.

9. The method of claim 1, wherein applying the electronic funds comprises:
retrieving based on the identified patient, a token associating the patient with electronic account information stored on a secure server;
sending the token to the secure server to initiate a process for applying the electronic funds using the electronic account information stored on the secure server.

10. A medical practice management server configured to process healthcare payments in accordance with at least one pre-authorization payment contract, the medical practice management server comprising at least one processor programmed to:
receive from a healthcare payer, an indication of an outstanding balance for a medical claim submitted to the healthcare payer on behalf of a medical practice;
identify a patient associated with the medical claim;
determine whether the identified patient is associated with a pre-authorized payment contract; and
apply based, at least in part, on one or more payment terms in the pre-authorized payment contract, electronic funds to at least a portion of the outstanding balance for the medical claim in response to determining that the identified patient is associated with a pre-authorized payment contract.

11. The medical practice management server of claim 10, wherein applying electronic funds to at least a portion of the outstanding balance comprises applying electronic funds to the entire outstanding balance.

12. The medical practice management server of claim 10, wherein the at least one processor is further programmed to:
determine that the outstanding balance is greater than a maximum amount specified in the pre-authorized payment contract; and
wherein applying electronic funds to at least a portion of the outstanding balance comprises applying electronic funds corresponding to the maximum amount specified in the pre-authorized payment contract to the outstanding balance.

13. The medical practice management server of claim 10, wherein the at least one processor is further programmed to:
determine whether the pre-authorized payment contract is valid prior to applying electronic funds to at least a portion of the outstanding balance; and
apply the electronic funds to at least a portion of the outstanding balance in response to determining that the pre-authorized payment contract is valid.

14. The medical practice management server of claim 10, wherein determining whether the pre-authorized payment contract is valid comprises determining whether a contract duration associated with the pre-authorized payment contract has expired and/or determining whether an authorized party has canceled the contract.

15. The medical practice management server of claim 14, wherein the at least one processor is further programmed to:
generate one or more automated messages in response to determining the pre-authorized contract is not valid, wherein the one or more automated messages comprise instructions regarding payment of the outstanding balance; and
transmit the one or more automated messages to the patient associated with the medical claim.

16. The medical practice management server of claim 10, wherein the at least one processor is further programmed to:
receive from the healthcare payer, a readjudicated claim including updated payment information for the medical claim; and
credit or debit an electronic account for the patient based, at least in part, on the updated payment information in the readjudicated claim.

17. The medical practice management server of claim 10, wherein applying the electronic funds comprises:
retrieving based on the identified patient, a token associating the patient with electronic account information stored on a secure server;
sending the token to the secure server to initiate a process for applying the electronic funds using the electronic account information stored on the secure server.

18. At least one computer-readable medium encoded with a plurality of instructions that, when executed by a computer, perform a method, comprising:
receiving from a healthcare payer, an indication of an outstanding balance for a medical claim submitted to the healthcare payer on behalf of a medical practice;
identifying a patient associated with the medical claim;
determining whether the identified patient is associated with a pre-authorized payment contract; and
applying based, at least in part, on one or more payment terms in the pre-authorized payment contract, electronic funds to at least a portion of the outstanding balance for the medical claim in response to determining that the identified patient is associated with a pre-authorized payment contract.
